(19) United States
(12) Patent Application Publication
(10) Pub. No.: US 2006/0164030 A1
(43) Pub. Date: Jul. 27, 2006

(54) Motor actuator

(75) Inventors: Yukinobu Kujira, Toyohashi-city (JP); Takahiro Inayoshi, Toyohashi-city (JP); Tokuhisa Takeuchi, Chita-gun (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); ASMO CO., LTD., Kosai-city (JP)

(21) Appl. No.: 11/337,093

(22) Filed: Jan. 23, 2006

(30) Foreign Application Priority Data
Jan. 24, 2005 (JP) 2005-016045
Oct. 25, 2005 (JP) 2005-310099

(51) Int. Cl. H02P 25/12

(52) U.S. Cl. 318/439; 318/640; 318/647

(57) ABSTRACT

A motor actuator for actuating a driven member includes a control unit and a brushless motor, which includes a coil, a magnet and a hall element. The coil generates a magnetic field when being energized. The magnet rotor is rotatable in the magnetic field generated by the coil. The hall element detects a variation in the magnetic field due to rotation of the magnet rotor. Then, the hall element outputs an output signal according to the variation in the magnetic field. The control unit detects a relative position between the magnet rotor and the coil based on the output signal outputted from the hall element, and controls energization of the coil based on the relative position. Furthermore, the control unit detects a location of the driven member, and controls the brushless motor to drive the driven member based on a rotation amount of the magnet rotor.

### CROSS REFERENCE TO RELATED APPLICATION

This application is based on and incorporates herein by reference Japanese Patent Applications No. 2005-16045 filed on Jan. 24, 2005 and No. 2005-310099 filed on Oct. 25, 2005.

### BACKGROUND OF THE INVENTION

1. Field of the Invention:

The present invention relates to a motor actuator for actuating a driven member (e.g., a damper used for a vehicle interior air conditioning), which is positioned based on a rotation amount of a driving member (e.g., brushless motor).

2. Description of Related Art:

Conventionally, an air-amount adjusting damper for a vehicle air conditioner is actuated by a motor actuator having a control mechanism, which controls an opening degree of the damper based on a rotation amount of a motor serving as a driving member of the motor actuator. The motor actuator includes a position detection sensor, such as a potentiometer, a cam switch and an encoder, which detects the rotation amount of the motor so that the motor actuator controls the opening degree of the damper. Some motor actuators detect a change of a current waveform of a DC brush motor that serves as the driving member.

For instance, Japanese Unexamined Patent Publication H5-252692 discloses a position detection sensor, in which the rotation amount of a motor is detected by use of a potentiometer that includes a plate and a brush. The plate is formed into a predetermined pattern shape, and is fixed in such a manner that the plate is integrally rotatable with a shaft. The brush slidably contacts the plate. A position detection sensor structured in this manner detects a rotational position of the shaft, which is rotated by the motor, based on a change of an electrical connecting relation between the plate and the brush. The electrical connecting relation is changed when the brush slidably moves on the plate, which rotates along with the shaft.

However, in Japanese Unexamined Patent Publication H5-252692, a space is required to allocate the position detection sensor. Thereby, this is disadvantage for reducing a size of the motor actuator. Also, a number of constituent members for the position detection sensor is increased, and as a result, an assembling process becomes complex.

In contrast, in a detection method for detecting a current waveform of a DC brush motor, the rotation speed can be detected without mounting a position detection sensor on a shaft. However, a degree of accuracy for detecting the shaft position becomes unstable because the waveform is changed by a load, a voltage and a temperature, and the degree of accuracy for detecting the shaft position is affected by noises. Also in the detection method, the current waveform of the motor is fed back, and therefore a positioning shift of the shaft after the current is stopped cannot be detected.

### SUMMARY OF THE INVENTION

The present invention addresses the above disadvantages. Thus, it is an objective of the present invention to provide a motor actuator that has a compact size while accurately controlling an actuation condition of a driven member, which is positioned based on a rotation amount of a driving member.

According to an aspect of the present invention, a motor actuator for actuating a driven member includes a brushless motor and a control unit. The brushless motor includes a coil that generates a magnetic field when being energized, a magnet rotor rotatable in the magnetic field generated by the coil, and a hall element that detects a variation in the magnetic field due to rotation of the magnet rotor and outputs an output signal according to the variation in the magnetic field. The control unit detects a relative position between the magnet rotor and the coil based on the output signal outputted from the hall element, and controls energization of the coil based on the relative position. In addition, the control unit detects a location of the driven member, and controls the brushless motor to drive the driven member based on a rotation amount of the magnet rotor. Accordingly, the motor actuator has a compact size while accurately controlling an actuation condition of the driven member based on a rotation amount of the magnet rotor.

The motor actuator can be provided with a counter that measures a number of variations in the output signal outputted from the hall element. Here, the variations in the output signal outputted from the hall element are generated according to the variation in the magnetic field. In this case, the control unit detects the location of the driven member based on the measured number.

Furthermore, the motor actuator can be provided with a speed reducing portion that reduces the rotation amount of the magnet rotor to a reduced value. In this case, the control unit controls the brushless motor to drive the driven member with the reduced value.

The speed reducing portion can include an output gear, through which the reduced value is transmitted to the driven member. Furthermore, a detected member can be located at a part of the output gear of the speed reducing portion to be rotated with the output gear, and a detecting means can be provided for detecting the detected member. In this case, the detecting means outputs a detection signal when the detecting means detects the detected member, and the control unit detects an initial position of the driven member based on the detection signal outputted from the detecting means.

Alternatively, the detected member is a detection conductor, and the detecting means is a slidable contact having a contact part arranged to slidably contact the output gear along an orbit. In this case, the detection conductor is located at a position of the output gear on the orbit, and the slidable contact detects the detection conductor when the contact part of the slidable contact contacts the detection conductor. Alternatively, the detected member is a sensor magnet located on the output gear, and the detecting means is a magnetic detection element that detects a change of a magnetic field due to rotation of the sensor magnet, which is rotated with the output gear. In this case, the magnetic detection element detects the sensor magnet based on the change of the magnetic field. Alternatively, the detected member is a reflector located on the output gear, and the detecting means includes a light-emitting device and a light-receiving device. In this case, the light-emitting device emits light toward the output gear along an orbit, the reflector is located at a position of the output gear on the orbit, the reflector reflects the light emitted by the light-emitting device when the reflector is located at a position corresponding to the initial position of the driven member, and the light-receiving means detects the reflector when the light-receiving device receives the light reflected by the reflector.

In the motor actuator, the brushless motor can be assigned with a first address, the control unit can be provided with a communication portion that receives an external control signal including a second address. In this case, the communication portion of the control unit determines whether the external control signal is dedicated to the brushless motor by a comparison between the first address and the second address, and the control unit controls the energization of the coil based on the external control signal when the first address assigned to the motor actuator is identical to the second address included in the external control signal.

Furthermore, the present invention can be applied to a motor actuator system provided with a plurality of the motor actuators. In this case, each of the motor actuators is assigned with a corresponding first address, and a controller is provided to control the control unit of each motor actuator and to output a control signal including a second address to the control unit. Furthermore, the control unit of each motor actuator further includes a communication portion that receives the control signal outputted from the controller, the communication portion of any one of the motor actuators determines whether the control signal outputted from the controller is for itself by a comparison between the first address of the one of the motor actuators and the second address included in the control signal, and the control unit controls the energization of the coil of the one of the motor actuators when the first address of the one of the motor actuators is identical to the second address included in the control signal.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view of a vehicle air conditioner, which includes a motor actuator according to a first embodiment of the present invention;

FIG. 2 is a schematic plan view of the motor actuator according to an example of the first embodiment of the present invention;

FIG. 3 is a schematic circuit diagram of the motor actuator according to the first embodiment of the present invention;

FIG. 4 is graphs showing relationships between output signals outputted from hall elements and a rotation angle of a rotor;

FIG. 5 is a schematic plan view of a motor actuator according to another example of the first embodiment of the present invention;

FIG. 6 is a schematic plan view of a motor actuator according to an example of a second embodiment of the present invention;

FIG. 7 is a schematic circuit diagram of the motor actuator according to the second embodiment of the present invention;

FIG. 8 is a schematic circuit diagram of the motor actuator according to the second embodiment of the present invention;

FIG. 9 is a side view of a motor actuator according to another example of the second embodiment of the present invention;

FIG. 10A is a side view of a motor actuator according to another example of the second embodiment of the present invention; and

FIG. 10B is a top view of the motor actuator shown in FIG. 10A.

### DETAILED DESCRIPTION OF PREFERRED EMBODIMENTS

### First Embodiment

The first embodiment of the present invention will be described with reference to the accompanying drawings.

A vehicle air conditioner has an air-conditioning duct 3, which includes inlet ports 1 for drawing air and outlet ports 2 for blowing out air into a vehicle compartment. The air conditioner also has a blower fan 4, an evaporator 5, a heater core 6 and dampers 7 in the air-conditioning duct 3. Outside air (i.e., air outside the vehicle compartment) or inside air (i.e., air inside the vehicle compartment) is supplied to the air-conditioning duct 3 through the inlet ports 1 by the blower fan 4, which is driven by a blower motor 4a. The air supplied to the air-conditioning duct 3 is dehumidified and cooled through the evaporator 5. Opening degrees of the dampers 7 are changed to selectively open and close the inlet ports 1 and the outlet ports 2 so that an airflow passage in the air-conditioning duct 3 is changed. The outside air or/and inside air can be drawn through the inlet ports 1 of the air-conditioning duct 3, and supplies warm air or cool air into the vehicle compartment through the outlet ports 2. Operational conditions of the blower fan 4, the evaporator 5, the heater core 6 and the dampers 7 are controlled based on signals outputted from control switches (not illustrated) that are controlled by an occupant.

The dampers 7 are controlled and driven by motor actuators 8, and specifically in the present embodiment, control arms 9 and control links 9a are arranged between the dampers 7 and the motor actuators 8. Here, the control arms 9 are fixed to the corresponding motor actuators 8, and the control links 9a connect the control arms 9 to the dampers 7, respectively. These structures of the motor actuators 8 for driving the dampers 7, respectively, through the control arms 9 and the control links 9a, can be made similarly. Here, the structure of a single motor actuator 8 is explained. The control arm 9 is fixed to an actuation shaft 8a of the motor actuator 8 in such a manner that the control arm 9 starts and stops its rotation based on an operation condition of the motor actuator 8. The control link 9a opens and closes the damper 7 based on the rotation of the control arm 9, and maintains the opening degree of the damper 7. In the present embodiment, the damper 7 is typically used as the driven member of the motor actuator 8. In this case, the opening degree of the damper 7 corresponding to an operation position of the driven member is determined by the motor actuators 8.

The opening degrees of the dampers 7 and operational conditions of the blower fan 4 and the like are determined based on the signals sent from control switches (not illustrated). Therefore, an air conditioning operation in the vehicle can be controlled by a manual switch operation of the occupant.

Next, the motor actuator 8 that actuate the damper 7 will be described with reference to FIGS. 2 to 5.

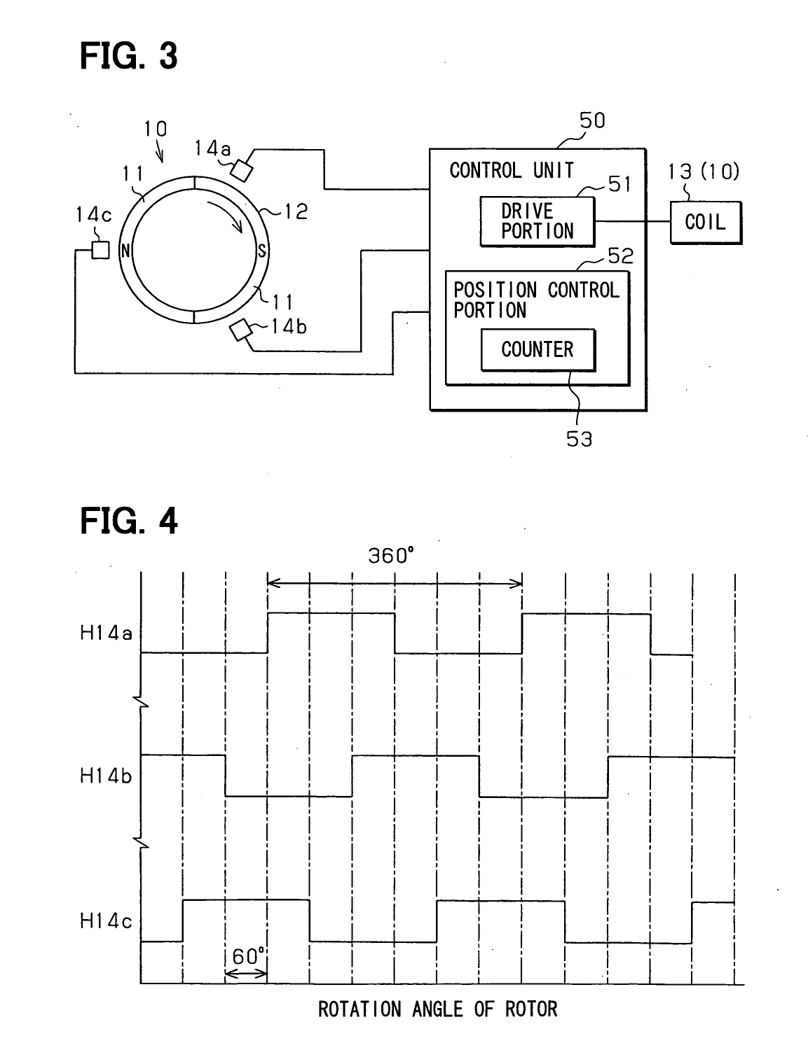

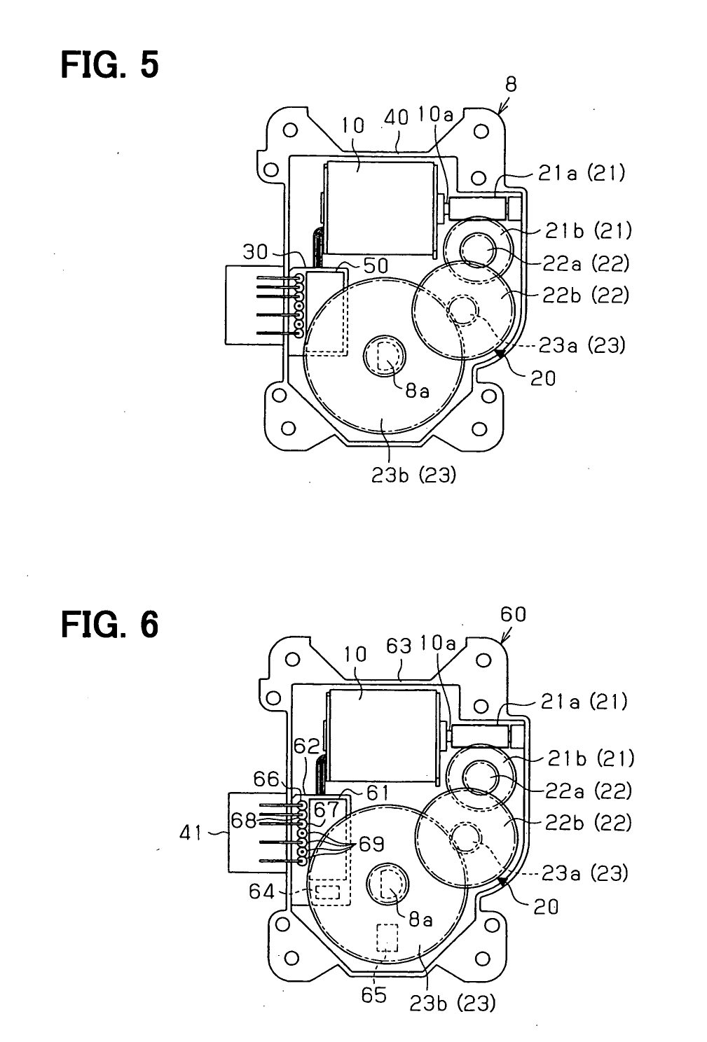

As shown in FIG. 2, the motor actuator 8 has a brushless motor 10, which serves as the driving member, and a speed reducing portion 20. Rotation of the brushless motor 10 is reduced by use of the speed reducing portion 20 so that reduced rotation is conveyed to the control arm 9. A rotation amount of the control arm 9 is determined based on the rotation amount of the brushless motor 10. That is a position of the damper 7, which serves as the driven member, is thus detected. Also, a wiring arrangement member 30 for supplying power to the brushless motor 10 is located in a box-shaped case 40 along with the brushless motor 10 and the speed reducing portion 20. A power supplying condition to the wiring arrangement member 30 is controlled through a control unit 50 (see FIG. 3) based on signals from the control switches (not illustrated). In the present embodiment, FIG. 2 shows the motor actuator 8, in which the control unit 50 is arranged outside the case 40. However, the control unit 50 may be alternatively arranged inside the case 40 (see FIG. 5). Alternatively, the control unit 50 may be structured integrally with the brushless motor 10 so that a printed circuit board for hall elements and a printed circuit board for a control circuit may be integrated, thereby effectively reducing a number of components. Also, a degree of flexibility of usage of the motor may be improved.

FIG. 3 shows the control unit 50 and the brushless motor 10 that includes a rotor 12 having a 2-pole magnet 11, a coil 13 and three hall elements 14a, 14b and 14c. The coil 13 generates a rotating magnetic field toward the rotor 12. The control unit 50 controls a power supply condition to the coil 13.

A change of the magnetic field due to a rotation of the rotor 12 is detected by the hall elements 14a, 14b and 14c, and is converted to a detection signal so that the detection signal is outputted to the control unit 50. The control unit 50 drives the brushless motor 10 based on the detection signal outputted from the hall elements 14a, 14b and 14c, and adjusts the opening degree of the damper 7 based on the signals outputted from the control switches (not illustrated).

The control unit 50 has a drive portion 51, which drives the brushless motor 10, and a position control portion 52, which detects the opening degree (operation position) of the damper 7.

The drive portion 51 detects a relative arrangement relation between the rotor 12 and the coil 13 based on the output signals outputted from the hall elements 14a, 14b and 14c, so as to change energization of the coil 13. The control unit 50 controls a start and a stop of the rotation of the brushless motor 10, and also controls the rotation speed of the brushless motor 10 by use of the drive portion 51, thereby changing or keeping the opening degree of the damper 7.

The position control portion 52 includes a counter 53, which counts the output signals outputted from the hall elements 14a, 14b and 14c. The output signals are inputted to the drive portion 51 of the control unit 50. Here, the output signals from the hall elements 14a, 14b and 14c are used as drive control output signals to drive the brushless motor 10. The position control portion 52 detects the rotation amount of the control arm 9, which is rotated from the initial position, based on a count value of the output signals counted by the counter 53.

Then, a detection method for detecting the opening degree of the damper 7 through the position control portion 52 will be described with reference to FIGS. 3 and 4. A horizontal axis in FIG. 4 shows a rotation angle of the rotor 12.

The rotor 12 of the brushless motor 10 according to the present embodiment has the 2-pole magnet 11, and each of the output signals outputted from the hall elements 14a, 14b and 14c takes one cycle for one rotation of the rotor 12. Also, the three hall elements 14a, 14b and 14c are arranged at an equal interval so that each phase difference between output signals outputted from the hall elements 14a, 14b and 14c is 120 degrees. Also, each output signal has one rising edge and one falling edge in one cycle. Therefore, in the brushless motor 10 according to the present embodiment, the control unit 50 detects one rising or falling edge of the output signals outputted from the hall elements 14a, 14b and 14c every time the rotor 12 rotates by 60 degrees.

Specifically, the position control portion 52 determines that the rotor 12 rotates by 60 degrees when the counter 53 counts the edges of each of the output signals outputted from the hall elements 14a, 14b and 14c. That is, the counter 53 counts variations of the output signals outputted from the hall elements 14a, 14b and 14c. Thus, the position control portion 52 detects the rotation amount of the rotor 12 based on the count value (i.e., the number of the edges) counted by the counter 53. Therefore, when correlation between the rotation amount of the rotor 12 and the opening degree of the damper 7 is prestored in the position control portion 52, the position control portion 52 can detect the opening degree of the damper 7 based on the count value counted by the counter 53. Thus, the control unit 50 detects the opening degree of the damper 7 based on the count value counted by the counter 53.

The counter 53 is set to calculate the count value of the output signals, for instance, in such a manner that addition or subtraction is performed in counting the count value according to a rotation direction of the rotor 12. The control unit 50 rotates the brushless motor 10 in either direction to control the opening degree of the damper 7 in such a manner that the opening degree of the damper 7 becomes a predetermined value, or specifically that the count value of the output signals becomes a predetermined value.

Then, a control method of the control unit 50 for controlling the opening degree of the damper 7 will be described with reference to FIG. 3.

The control unit 50 drives the brushless motor 10 based on the signals from the control switches (not illustrated). Specifically, the control unit 50 energizes the coil 13 by use of the drive portion 51 to generate the magnetic field so that the rotor 12 rotates.

The hall elements 14a, 14b and 14c output signals to the control unit 50 according to a magnetic field change, which is caused by the rotation of the rotor 12.

The control unit 50 changes the current supplied to the coil 13 based on the output signals from the hall elements 14a, 14b and 14c, by using the drive portion 51 so that the rotating magnetic field is generated. Also, the control unit 50 counts the variations of the output signals by using the counter 53 of the position control portion 52.

The position control portion 52 of the control unit 50 detects the opening degree of the damper 7. When the opening degree of the damper 7 becomes the predetermined value, for example, when the count value of the counter 53 becomes the predetermined value, the control unit 50 stops rotating the brushless motor 10, and keeps the set opening degree of the damper 7.

Next, the speed reducing portion 20 will be described.

The speed reducing portion 20 has a first speed reducing mechanism 21, a second speed reducing mechanism 22 and a third speed reducing mechanism 23 as shown in FIG. 2.

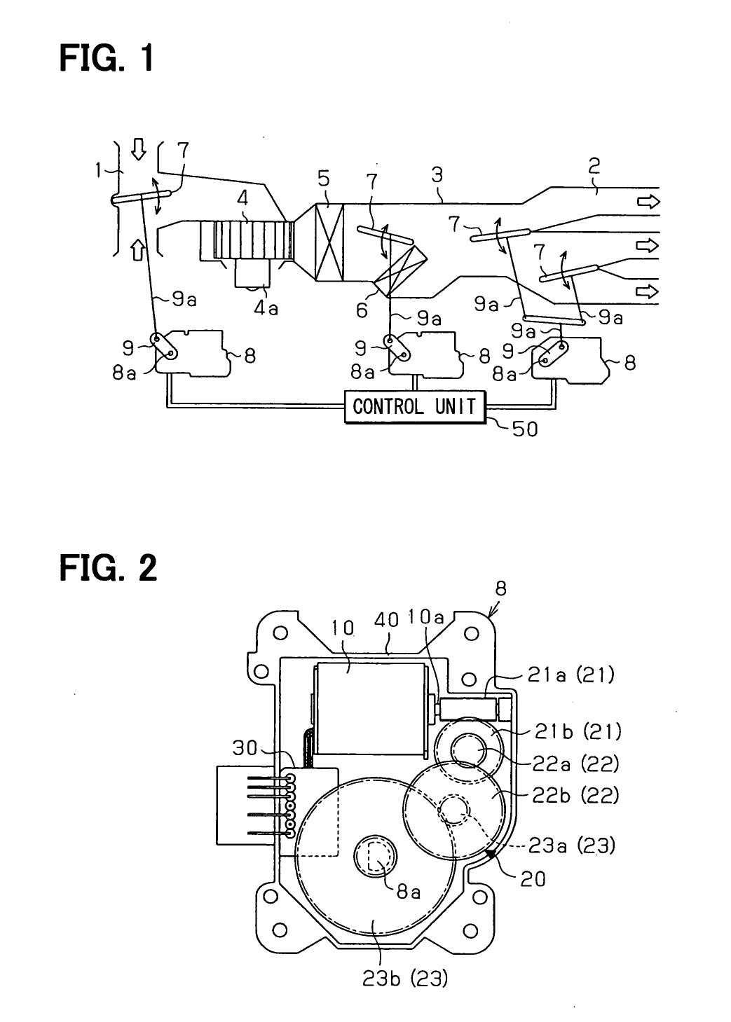

The first speed reducing mechanism 21 has a worm gear 21a, which is fixed to an output shaft 10a of the brushless motor 10, and a worm wheel 21b, which is engaged with the worm gear 21a. The second speed reducing mechanism 22 includes a first driving spur gear 22a and a first driven spur gear 22b. The first driving spur gear 22a is coaxially fixed to the worm wheel 21b, and a diameter of the first driving spur gear 22a is smaller than that of the worm wheel 21b. The first driven spur gear 22b is engaged with the first driving spur gear 22a, and a diameter of the first driven spur gear 22b is larger than that of the first driving spur gear 22a. The third speed reducing mechanism 23 includes a second driving spur gear 23a and a second driven spur gear 23b. The second driving spur gear 23a is coaxially fixed to the first driven spur gear 22b, and a diameter of the second driving spur gear 23a is smaller than that of the first driven spur gear 22b. The second driven spur gear 23b is engaged with the second driving spur gear 23a, and a diameter of the second driven spur gear 23b is larger than that of the second driving spur gear 23a. The actuation shaft 8a is fixed at a generally radial center portion of the second driven spur gear 23b. Here, the actuation shaft 8a is fixed to the control arm 9 (see FIG. 1). Accordingly, the rotation speed of the brushless motor 10 is reduced in three steps through the speed reducing portion 20 so that the reduced rotation is conveyed to the control arm 9 (see FIG. 1).

For instance, if a speed reducing ratio by the speed reducing portion 20 is 1/600, the control arm 9 rotates by 0.1 degree when the rotor 12 of the brushless motor 10 rotates by 60 degrees. In this case, the control unit 50 detects the variation of the output signals outputted from the hall elements 14a, 14b and 14c every time the control arm 9 rotates by 0.1 degree. Therefore, a control operation of the motor actuator 8 for controlling the damper 7 can be performed in detail by use of the speed reducing portion 20.

According to the present embodiment, the following advantages can be obtained.

First, a special position detection sensor, which detects the rotation amount of the brushless motor 10 to determine the opening degree of the damper 7, is not required, because the position control portion 52 can determine the opening degree of the damper 7 based on the output signals outputted from the hall elements 14a, 14b and 14c. Therefore, the size of the motor actuator 8 can be effectively reduced compared with a conventional motor actuator that has the position detection sensor.

Also, the control unit 50 recognizes the opening degree of the damper 7 by detecting the rotation amount of the brushless motor 10 (or, the rotation amount of the control arm 9) based on the output signals outputted from the hall elements 14a, 14b and 14c. This means that the control unit 50 performs the drive control of the brushless motor 10 and the position control of the damper 7 based on the identical output signals from the hall elements 14a, 14b and 14c. Thus, the control unit 50 can perform a feedback control, which limits operational position errors, so that the control unit 50 can accurately control the opening degree of the damper 7. Also in the present embodiment, the control unit 50 uses the output signals when detecting the opening degree of the damper 7. Therefore, the degree of accuracy in detection is stable against a change of a load, a voltage and a temperature, and is not affected by noises in contrast with the case of the conventional position detection sensor, which uses the change of current waveform of the DC brush motor in detection.

Also, because the brushless motor 10 serves as the actuator, sliding noises are not generated so that the brushless motor 10 contributes to the reduction of noises inside the vehicle. Also, because slidable contacts, which are required in the conventional technique, are not required in the present invention, wear is prevented. Thus, a degree of durability is improved.

Furthermore, the position control portion 52 of the control unit 50 counts the variation of the output signals outputted from the hall elements 14a, 14b and 14c by using the counter 53 so as to determine the opening degree of the damper 7. Therefore, the rotation amount of the rotor 12, which rotates more than or equal to one revolution, can be associated with the opening degree of the damper 7 by use of the counter 53. Because the brushless motor 10 is operated with a high-speed rotation control, the speed-reducing ratio can be made greater, and a greater torque can be obtained. As a result, a small-sized motor can be used, and the motor actuator 10 can be made compact.

In addition, a variation amount of the opening degree of the damper 7 per one rotation of the brushless motor 10 can be reduced by use of the speed reducing portion 20. Thus, the control unit 50 can be controlled in detail so that the opening degree of the damper 7 is more accurately set.

The first embodiment of the present invention can be suitably modified in the following manner.

In the above-described first embodiment, the motor actuator 8 is typically set to controls the opening degree of the damper 7 of the vehicle air conditioner. However, the motor actuator 8 is not so limited. For instance, the motor actuator 8 may serve as an actuator for a mechanism, where a position of a control target is detected based on the rotation amount of the brushless motor 10 that serves as the driving member of the motor actuator 8. Such a mechanism can include a lead screw device. The motor actuator 8 can be easily used for a driven member only if a correlation between the count value and the position of a driven member is correspondingly set by use of the position control portion 52.

In the above-described first embodiment, the brushless motor 10 has the rotor 12, which includes the 2-pole magnet 11 and the three hall elements 14a, 14b and 14c. However, a number of hall elements and a number of magnets may be suitably modified. For instance, when the numbers of the hall elements and the magnets are increased, a number of the variations (e.g., edges) of the output signals outputted from the hall elements during one revolution of the rotor 12 is increased. Therefore, detail control performance of the control unit 50 can be further improved, and the opening degree of the damper 7 can be more accurately set.

In the above-described first embodiment, the control arm 9 and the control link 9a are arranged between the damper 7 and the motor actuator 8. However, the conditions are not so limited. Alternatively, the actuation shaft 8a of the motor actuator 8 may be directly connected with the damper 7.

### Second Embodiment

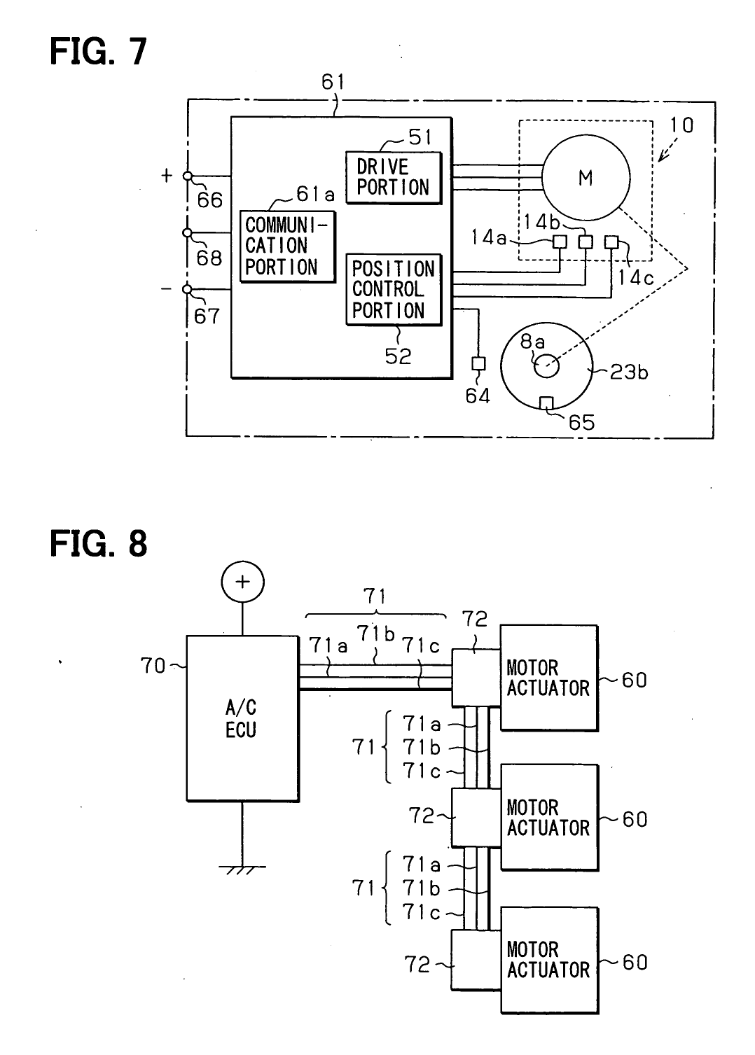

The second embodiment of the present invention will be described with reference to FIGS. 6 to 8. Components of a motor actuator 60 of the second embodiment, which are similar to the components of the motor actuator 8 of the first embodiment, will be indicated by the same numerals. Different features from the first embodiment will be mainly described. In FIG. 7, the brushless motor 10, the magnet 11, the rotor 12 and the coil 13 are omitted for simply indicating the drawing.

As shown in FIG. 6, the motor actuator 60 according to the second embodiment includes the brushless motor 10, the speed reducing portion 20, a circuit board 62 structuring a control unit 61. The motor actuator 60 autonomously controls the damper 7 (see FIG. 1) serving as a driven member, based on control signals outputted from an air-conditioning electronic control unit (ECU) 70. The circuit board 62 is fixed to a case 63 in such a manner that a part of the circuit board 62 faces an end face of the second driven spur gear 23b, which is coaxially fixed to the actuation shaft 8a. A detecting means and a hall element 64 serving as a magnetic detecting element are provided on the circuit board 62 around a part, which faces the second driven spur gear 23b.

A sensor magnet 65 serving as a detected member is fastened to the second driven spur gear 23b serving as the output gear of the motor actuator 60. The sensor magnet 65 is located on the end face of the second driven spur gear 23b at a predetermined angle position of the second driven spur gear 23b in such a manner that the sensor magnet 65 faces the hall element 64 on the circuit board 62. Specifically, the sensor magnet 65 faces the hall element 64 when the damper 7 shown in FIG. 1 is positioned at the initial position. The hall element 64 detects a magnetic field change due to a displacement of the sensor magnet 65, and outputs a detection signal. The control unit 61 recognizes that the damper 7 is located at the initial position based on the detection signal outputted from the hall element 64. Then, the control unit 61 controls the opening degree of the damper 7 on the basis of the initial position.

In the present embodiment, as shown in FIG. 8, multiple motor actuators 60 (three motor actuators in the present embodiment) are connected in series with the air-conditioning ECU 70 through a corresponding harness 71 that includes a control signal wire 71a, a power wire 71b and a ground wire 71c. In this case, each harness 71 includes a corresponding external connector 72, which corresponds to each of the motor actuators 60. Each external connector 72 is connected with a connection member 41 of each motor actuator 60.

As shown in FIG. 6, the connection member 41 of the motor actuator 60 includes a power terminal 66, a ground terminal 67 and a control signal terminal 68. The external connector 72 is connected with the connection member 41 in such a manner that the power terminal 66 is connected with the power wire 71b, the ground terminal 67 is connected with the ground wire 71c, and the control signal terminal 68 is connected with the control signal wire 71a. The control unit 61 is supplied with power by the air-conditioning ECU 70 through the power terminal 66, which is connected with the power wire 71b. Also, the control unit 61 is grounded through the ground terminal 67, which is connected with the ground wire 71c. The control signals that are outputted from the air-conditioning ECU 70 are inputted to the control unit 61 through the control signal terminal 68, which is connected with the control signal wire 71a.

As shown in FIG. 7, the control unit 61 includes the drive portion 51, the position control portion 52 and a communication portion 61a. The connection portion 61a enables communication of the control signals between the air-conditioning ECU 70 and each motor actuator 60.

Specifically, the connection member 41 of each motor actuator 60 includes an address terminal 69 (see FIG. 6), which is set to have its own hardware address so that each motor actuator 60 can be identified on a network. It is noted that in FIG. 7, the address terminal 69 is omitted. The air-conditioning ECU 70 outputs a control signal that includes address information indicative of a target motor actuator 60. When inputted with the control signal, each motor actuator 60 determines whether the control signal is targeted (dedicated) to itself based on the address information. Therefore, the multiple motor actuators 60 can use the control signal wire 71a in common so that the multiple motor actuators 60 are connected in series with the air-conditioning ECU 70 as shown in FIG. 8.

The present embodiment provides the effects described in the first embodiment and the following effects.

(1) In the present embodiment, the sensor magnet 65 of the second driven spur gear 23b and the hall element 64 are provided. Thus, the initial position of the damper 7 can be easily detected (set) when the second driven spur gear 23b, which actuates the damper 7, is rotated at a low rotation speed by use of the speed reducing portion 20. A mechanical critical position, where the damper 7 could be mechanically arranged by use of the drive of the brushless motor 10, may be set as the initial position of the damper 7. However, in this case, the initial position might be unstably set due to a change of torque of the brushless motor 10 according to a supplied voltage to the motor and an atmospheric temperature. In contrast, in the present embodiment, the initial position of the damper 7 can be accurately set, because the initial position of the damper 7 is set by use of the hall element 64 and the sensor magnet 65 that is provided to the second driven spur gear 23b. As a result, in the present embodiment, the initial position of the damper 7 can be stably set even when the torque changes.

(2) By use of the sensor magnet 65 and the hall element 64, the second driven spur gear 23b is not required to contact other members in the detection of the initial position of the spur gear 23b. Therefore, the drive power of the brushless motor 10 can be effectively transmitted to the damper 7.

(3) Because the control unit 61 is received in the case 63 of the motor actuator 60 along with the brushless motor 10, there is no need of signal wires, which would be needed if the control unit were located outside the case 63, to communicate with the externally located control unit for exchanging pulse signals and detected signals. These signals are needed to drive the brushless motor 10. Thus, it is possible to reduce a number of the signal wires, which are connected with the motor actuator 60 for controlling the motor actuator 60, in comparison with the case that the control unit is externally located. For example, when the control unit 50 is located outside the motor actuator 8, a harness of eight wires is needed for connection between the motor actuator 8 and the control unit 50. Two of the eight wires correspond to power wires, and six of the eight wires correspond to signal wires for the coil 13, and the hall elements 14a, 14b and 14c. In contrast, when the control unit 61 is received in the case 63, the harness 71 for connection to the motor actuator 60 includes only three wires, which are two power wires (the power wire 71b and the ground wire 71c) and one communication wire (the control signal wire 71a).

(4) By use of the communication portion 61a of the control unit 61, the control unit 61 can determine whether the control signal is dedicated to itself or another motor actuator 60 based on the address information in the control signal. Therefore, the control signal wire 71a can be used in common among the multiple motor actuators 60 so that the harness 71 includes a less number of wires. Also, in this case, the air-conditioning ECU 70 can be connected in series with the multiple motor actuators 60 so that the number of the harnesses 71 can be reduced.

For instance, as described in the effect (3), when the control unit 50 is located outside the motor actuator 60, a number of wires that extends from each control unit 50 is eight. If there are five motor actuators 60, the number of the wires becomes 40. However, because the control unit 61 is located inside the case 63 of the motor actuator 60, and includes the communication portion 61a in the present embodiment, the harness 71 that extends from the control unit 61 includes only three wires. Thus, the number of wires included in the harness 71 for controlling the motor actuators 60 can be reduced.

Alternatively, the embodiment of the present invention may be modified as follows.

In the second embodiment, the address of each motor actuator 60 is the hardware address based on the address terminal 69. However, a software address can be used for the address of each motor actuator 60.

In the second embodiment, the hall elements 14a, 14b and 14c serve as the magnetic detection element. However structures are not so limited. For instance, a magnetic resistance effect element may be alternatively used for the magnetic detection element.

In the second embodiment, the initial position is detected by detecting the magnetic field change due to the rotation of the second driven spur gear 23b by use of the hall element 64 serving as the detecting means and the sensor magnet 65 serving as the detected member. However, a structure for detecting the initial position is not so limited, and may be alternatively modified.

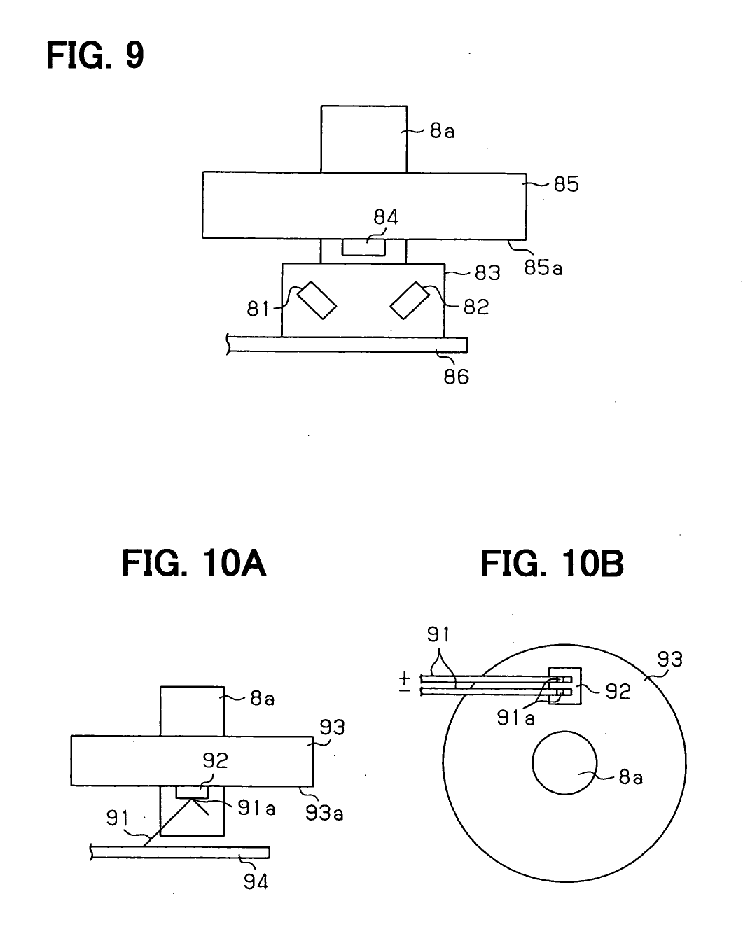

For instance, as shown in FIG. 9, the initial position may be detected by use of a reflector 84 serving as the detected member and an optical sensor 83 having a light-emitting device 81 and a light-receiving device 82. Specifically, the reflector 84 is fixed to an end face 85a of a second driven spur gear 85 so that the reflector 84 face a circuit board 86, and is located away from a rotation center. In contrast, the optical sensor 83 is located on a part of the circuit board 86 so that the optical sensor 83 faces the second driven spur gear 85. Here the second driven spur gear 85 is connected to the actuation shaft 8a. The optical sensor 83 includes the light-emitting device 81 and the light-receiving device 82. The light-emitting device 81 emits light to the second driven spur gear 85 along an orbit. The reflector 84 is located at a position on the orbit. Here, the reflector 84 is fixed to the second driven spur gear 85. Then, the light is reflected by the reflector 84. The light-receiving device 82 detects (or, receives) the reflected light reflected by the reflector 84, and outputs a detection signal. The optical sensor 83 and the reflector 84 are arraigned such that the light-receiving device 82 receives the light when the damper 7 is located at the initial position. Also, the control unit 61 can recognize that the damper 7 is located at the initial position based on the detection signals outputted from the light-receiving device 82.

Alternatively, as shown in FIGS. 10A and 10B, the initial position can be detected by use of a slidable contact 91 serving as the detecting means and a detection conductor 92 serving as the detected member. Specifically, the detection conductor 92 is fixed to (or, is formed integrally with) an end face 93a of a second driven spur gear 93 so that the detection conductor 92 faces a circuit board 94, and is located away from a rotation center. Here, the second driven spur gear 93 is connected to the actuator shaft 8a. In contrast, the slidable contact 91 is arranged on the circuit board 94 to face the second driven spur gear 93, and is fixed so that a contact part 91a of the slidable contact 91 slidably contacts the end face 93a of the second driven spur gear 93 along an orbit. The detection conductor 92 is located at a position on the orbit. The slidable contact 91 and the detection conductor 92 are arranged so that the slidable contact 91 contacts the detection conductor 92 when the damper 7 is located at the initial position. The slidable contact 91 is connected with the control unit 61 so that the control unit 61 can recognize that the damper 7 is located at the initial position, based on the contact between the detection conductor 92 and the slidable contact 91.

Additional advantages and modifications will readily occur to those skilled in the art. The invention in its broader terms is therefore not limited to the specific details, representative apparatus, and illustrative examples shown and described.

What is claimed is:

1. A motor actuator for actuating a driven member, comprising:
a brushless motor that includes
a coil that generates a magnetic field when being energized,
a magnet rotor rotatable in the magnetic field, which is generated by the coil, and
a hall element that detects a variation in the magnetic field due to rotation of the magnet rotor, wherein the hall element outputs an output signal according to the variation in the magnetic field; and
a control unit that detects a relative position between the magnet rotor and the coil based on the output signal outputted from the hall element, and controls energization of the coil based on the relative position,
wherein the control unit detects a location of the driven member, and controls the brushless motor to drive the driven member based on a rotation amount of the magnet rotor.

2. The motor actuator according to claim 1, further comprising a counter that measures a number of variations in the output signal outputted from the hall element, wherein:
the variations in the output signal outputted from the hall element are generated according to the variation in the magnetic field; and
the control unit detects the location of the driven member based on the measured number.

3. The motor actuator according to claim 1, further comprising a speed reducing portion that reduces the rotation amount of the magnet rotor to a reduced value, wherein the control unit controls the brushless motor to drive the driven member with the reduced value.

4. The motor actuator according to claim 3, wherein the speed reducing portion includes an output gear, through which the reduced value is transmitted to the driven member, the motor actuator further comprising:
a detected member that is located at a part of the output gear of the speed reducing portion to be rotated with the output gear; and
a detecting means for detecting the detected member, wherein:
the detecting means outputs a detection signal when the detecting means detects the detected member; and
the control unit detects an initial position of the driven member based on the detection signal outputted from the detecting means.

5. The motor actuator according to claim 4, wherein:
the detected member is a detection conductor;
the detecting means is a slidable contact having a contact part arranged to slidably contact the output gear along an orbit;
the detection conductor is located at a position of the output gear on the orbit; and
the slidable contact detects the detection conductor when the contact part of the slidable contact contacts the detection conductor.

6. The motor actuator according to claim 4, wherein:
the detected member is a sensor magnet located on the output gear;
the detecting means is a magnetic detection element that detects a change of a magnetic field due to rotation of the sensor magnet, which is rotated with the output gear; and
the magnetic detection element detects the sensor magnet based on the change of the magnetic field.

7. The motor actuator according to claim 4, wherein:
the detected member is a reflector located on the output gear;
the detecting means includes a light-emitting device and a light-receiving device;
the light-emitting device emits light toward the output gear along an orbit;
the reflector is located at a position of the output gear on the orbit;
the reflector reflects the light emitted by the light-emitting device when the reflector is located at a position corresponding to the initial position of the driven member; and
the light-receiving means detects the reflector when the light-receiving device receives the light reflected by the reflector.

8. The motor actuator according to claim 1, wherein:
the brushless motor is assigned with a first address;
the control unit further includes a communication portion that receives an external control signal including a second address;
the communication portion of the control unit determines whether the external control signal is dedicated to the brushless motor by a comparison between the first address and the second address; and
the control unit controls the energization of the coil based on the external control signal when the first address assigned to the motor actuator is identical to the second address included in the external control signal.

9. A motor actuator system comprising:
a plurality of the motor actuators according to claim 1, wherein each of the motor actuators is assigned with a corresponding first address; and
a controller that controls the control unit of each motor actuator, wherein the controller outputs a control signal including a second address to the control unit, wherein:
the control unit of each motor actuator further includes a communication portion that receives the control signal outputted from the controller;
the communication portion of any one of the motor actuators determines whether the control signal outputted from the controller is for itself, by a comparison between the first address of the one of the motor actuators and the second address included in the control signal; and
the control unit controls the energization of the coil of the one of the motor actuators when the first address of the one of the motor actuators is identical to the second address included in the control signal.

10. The motor actuator according to claim 1, wherein the driven member is a damper that adjusts an airflow amount in a vehicle air conditioning system.
